(19) United States
(12) Patent Application Publication
(10) Pub. No.: US 2014/0311026 A1
(43) Pub. Date: Oct. 23, 2014

(54) METHODS AND DEVICES FOR PROTECTING PLANTS FROM UNDERGROUND DWELLING MAMMALS

(71) Applicant: Aleen Beth Ferris, Simi Valley, CA (US)

(72) Inventor: Aleen Beth Ferris, Simi Valley, CA (US)

(73) Assignee: A.B. JOHNSON, INC., Simi Valley, CA (US)

(21) Appl. No.: 14/197,135

(22) Filed: Mar. 4, 2014

Related U.S. Application Data
(60) Provisional application No. 61/799,310, filed on Mar. 15, 2013.

(51) Int. Cl. A01M 29/30

(52) U.S. Cl. CPC A01M 29/30
USPC 47/32.3; 47/20.1

(57) ABSTRACT

A method of protecting plants from underground dwelling mammals provides for the insertion of devices having pointed elongated members adjacent the root systems of the plants. A device for this purpose has a plurality of pointed elongated members joined by a handle section.

### CROSS-REFERENCE TO RELATED APPLICATION

This non-provisional application claims the benefit of U.S. provisional application 61/799,310, filed on Mar. 15, 2013, for “Methods and Devices for Protecting Plants from Underground Dwelling Mammals,” by Aleen Beth Ferris. The disclosure of that provisional application is incorporated by reference as if fully disclosed herein to the full extent permitted by treaty, law, and regulation.

### FIELD OF THE INVENTION

The field of the invention is that of devices and methods for preventing damage to plants caused by underground dwelling mammals.

### BACKGROUND OF THE INVENTION

Gophers eat the roots of vegetables and other plants. Moles are carnivorous but may disturb the roots of vegetables and other plants. These ground dwelling mammals must be controlled in areas where they are present in order to permit the growth and successful harvesting of plants.

Chemicals have been used to deter or kill underground dwelling mammals. This may introduce undesirable chemicals in the vicinity of food. For this reason, some farmers will prefer to grow pesticide-free vegetables. Others may prefer to use non-synthetic pesticides, such as those of animal or vegetable origin, in order to attain an “organic” rating for their plants. However, such non-synthetic pesticides may be of lesser utility in combating determined underground dwelling mammals.

Devices have been employed to kill or capture underground dwelling mammals, such as traps. This will result, if successful, in carcasses or live mammals which will need disposal. Other devices are designed to scare or annoy the underground dwelling animals, such as by the use of sound signals. Such devices are expensive and complicated. The underground dwelling mammals may grow accustomed to the signals or even be drawn to them because they associate them with adjacent food.

Alternatively, a farmer may employ carnivorous animals such as terriers and ferrets to dig up or pursue and then kill the underground dwelling mammals. This requires acquiring and maintaining an animal. The carnivorous animal may be likely to make holes in the ground as it attempts to unearth the underground dwelling mammal.

Another way to prevent damage from underground dwelling mammals is to provide barriers. For example, the bottom of a raised bed may be provided with wire mesh or netting having gaps too small to permit the passage of the underground dwelling mammals. This approach requires a significant investment of money and time.

An efficient, safe, and inexpensive device and method for preventing damage to plants from underground dwelling mammals is needed.

### SUMMARY OF THE INVENTION

According to one embodiment of the invention, a method is provided for protecting plants from underground dwelling mammals comprising the steps of providing at least one device comprising at least one elongated member with a first end, the first end being shaped to have a point, inserting the first end of the elongated member of the device into the soil adjacent the root system of a plant, and aligning the elongated member so that the first end of the elongated member is adjacent a bottom of the root system whereby the underground dwelling mammal will encounter the point of the first end of the elongated member when the underground dwelling mammal burrows toward the bottom of the root system.

A device for protecting plants from underground dwelling mammals is provided, comprising an elongated member having a handle section connected to two straight and generally parallel segments extending away from the handle section and each of the straight and generally parallel segments terminating in an end, at least one of the ends being pointed, wherein the straight and generally parallel segments have a length sufficient to extend to the bottom of the root system of a plant when the straight and generally parallel segments are inserted into the soil adjacent the plant. Preferably both ends are pointed and the points are sharp in order to inflict pain on an underground dwelling mammal that encounters one of the points when the device is inserted into the soil next to the root system of a plant. The device may be formed by bending a piece of wire to form the handle section and the straight and generally parallel segments. Alternatively, the device may be formed from extruded polymer.

### DESCRIPTION OF THE DRAWINGS

FIG. 1 in the drawings is a perspective view from the side of a vegetable plant V in the ground being eaten by a gopher G. The gopher G approaches the root system R of the vegetable plant V from beneath and drags the vegetable plant V down from the surface of the ground as the gopher G it eats the vegetable plant V. Eventually, the gopher G may consume the entire vegetable plant V.

FIG. 2 is a perspective view from the side of the vegetable plant V of FIG. 1 protected from the gopher G by an embodiment of a device for protecting the vegetable plant V from underground dwelling mammals such as the gopher G.

FIG. 3 is side plan view of the device for protecting the vegetable plant V from underground dwelling mammals that is shown in FIG. 2.

FIG. 4 is a side plan view of a longer version of the device for protecting the vegetable plant V from underground dwelling mammals that is shown in FIG. 2.

FIG. 5 is an expanded view of the portion, indicated by circle 5 in FIG. 3, of the device for protecting the vegetable plant V from underground dwelling mammals that is shown in FIG. 3.

FIG. 6 is a cross-section, taken along the plane 6-6, of the portion of one version of the device for protecting the vegetable plant V from underground dwelling mammals that is shown in the expanded view of FIG. 5.

FIG. 7 is a cross-section, taken along the plane 7-7, of the portion of a second version of the device for protecting the vegetable plant V from underground dwelling mammals that is shown in the expanded view of FIG. 5.

FIG. 8 is a cross-section, taken along the plane 8-8, of the portion of a third version of the device for protecting the vegetable plant V from underground dwelling mammals that is shown in the expanded view of FIG. 5.

FIG. 9 is a side perspective view of a vegetable plant V showing the insertion of a set of the devices for protecting the vegetable plant V from underground dwelling mammals.

FIG. 10 is a side perspective view of the vegetable plant V of FIG. 9 after completion of the insertion of the set of the devices for protecting the vegetable plant V from underground dwelling mammals.

FIG. 11 is a side perspective view of the upper portion of the vegetable plant V and devices for protecting the vegetable plant V from underground dwelling mammals as shown in FIG. 10.

FIG. 12 is a top perspective view of the upper portion of the vegetable plant V and devices for protecting the vegetable plant V from underground dwelling mammals as shown in FIG. 11.

FIG. 13 is an oblique perspective view of a line of vegetable plants V and an interspersed series of devices for protecting the vegetable plant V from underground dwelling mammals.

FIG. 14 is an oblique perspective view of a line of vegetable plants V and an interspersed series of devices for protecting the vegetable plant V from underground dwelling mammals arranged in a different orientation.

FIG. 15 is a side perspective view of a seedling vegetable plant S with a device for protecting vegetable plants from underground dwelling mammals.

FIG. 16 is an oblique perspective view of two rows of seedling vegetable plants S each associated with a device for protecting vegetable plants from underground dwelling mammals.

### DETAILED DESCRIPTION OF PREFERRED EMBODIMENTS OF THE INVENTION

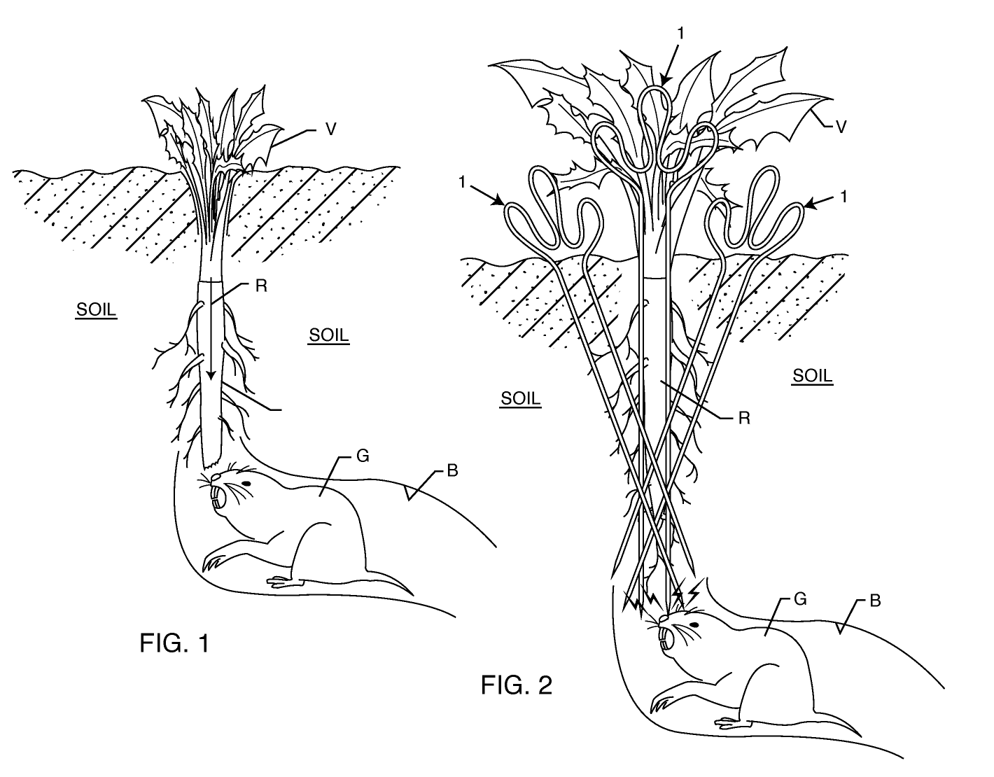

FIG. 1 illustrates the problem addressed by the methods and devices described in this specification. A vegetable plant V, having been planted in soil, has been located by a gopher G. The gopher G burrows up to the bottom of the root system R of the vegetable plant V and begins to eat its root system R. As the gopher G eats, it drags down the vegetable plant V into its burrow B in the direction shown by the arrow D in order to continue eating without leaving the shelter of the burrow B or having to expand the burrow B upwardly. Eventually the vegetable plant V will seem to sink into a hole in the soil, never to be seen again. It will be understood that plants other than vegetable plants may be subject to attack in this manner and may be protected by the methods and devices described in this specification.

FIG. 2 shows embodiments of devices 1 for protecting plants from underground dwelling mammals having been inserted into the soil around the root system R of the vegetable plant V. The points of the lower ends 6 of the devices 1 repel the gopher G from eating the root system R.

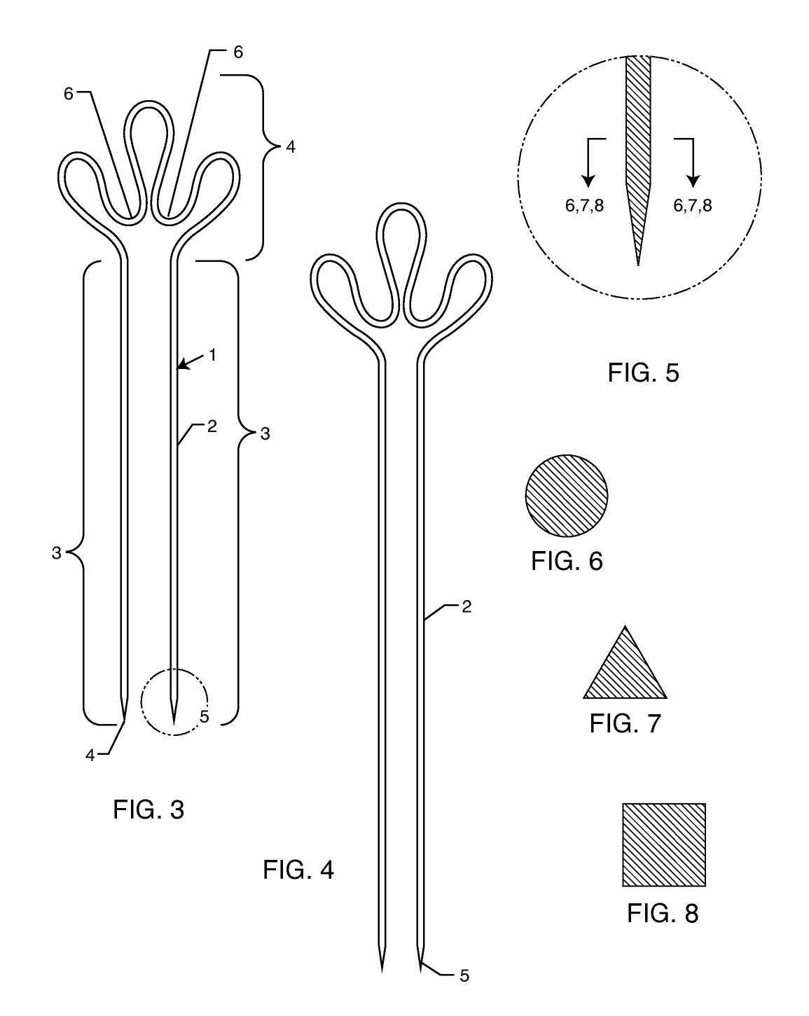

FIG. 3 shows one of the devices 1. The device 1 is made of an elongated member 2 that is generally U-shaped. The elongated member 2 has two generally parallel segments 3 that terminate in two ends 6. The ends 6 are sharply pointed, as is shown best in FIG. 5, in order to repel underground dwelling mammals such as gophers. Gophers detect food by smell rather than by sight because they approach a plant such as a vegetable plant V from underground. A gopher will encounter the ends 6 of the device 1 as it approaches a vegetable plant V protected by the devices 1. The sharp points of the ends 6 are capable of inflicting wounds, which is painful to the gopher. The gopher will learn to avoid the vegetable plant V due to its association with pain. In general, the device 1 is more effective if its ends 6 are more sharply pointed. The sharpness of the point of the end 6 is limited only by the strength of the material of which the device 1 is made. The end 6 should remain sharp after the device 1 is driven into the soil. A point that is too sharp in view of the strength of the material will be susceptible to blunting or bending.

The elongated member 2 is shaped so between the segments 3 is a handle section 4. As shown, the handle section 4 has a trefoil design that serves well as a handle but may have other outlines that would be satisfactory for that purpose. The trefoil design has the advantage of providing two indentations 6 that permit the device 1 to support vines such as those of cucumbers.

The elongated member 2 may be made of wire or extruded polymer. Preferably, the material of which the elongated members 2 are made should be inexpensive so that the average gardener may be able to afford the number needed. The material must be strong enough to permit a gardener to insert the elongated members into the soil adjacent to the root system of a plant. FIGS. 6-8 show three of the possible cross-sectional shapes of the elongated member 2. Preferably, the devices 1 should have generally parallel segments 2 of a length of nine to ten inches.

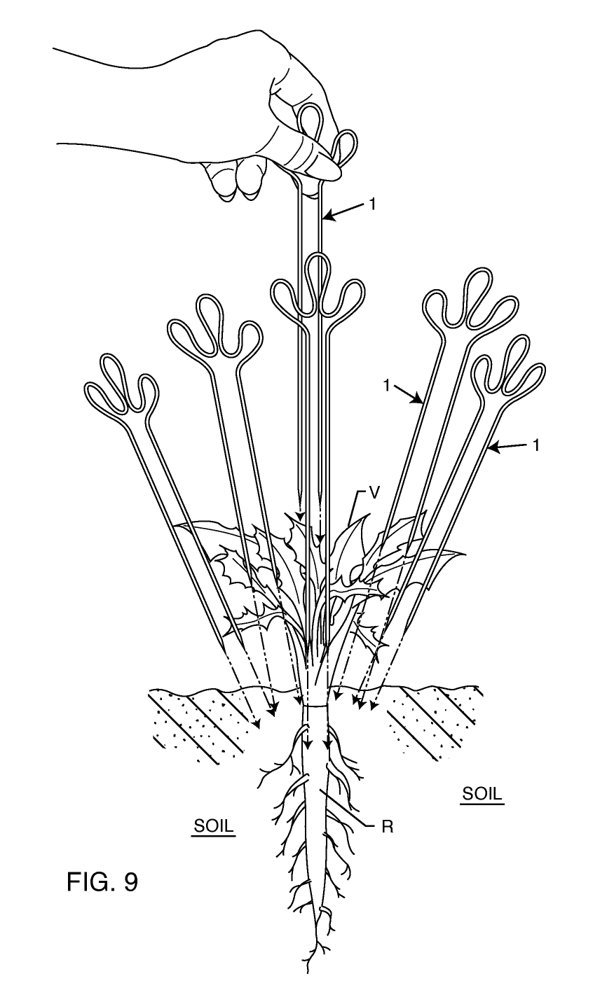

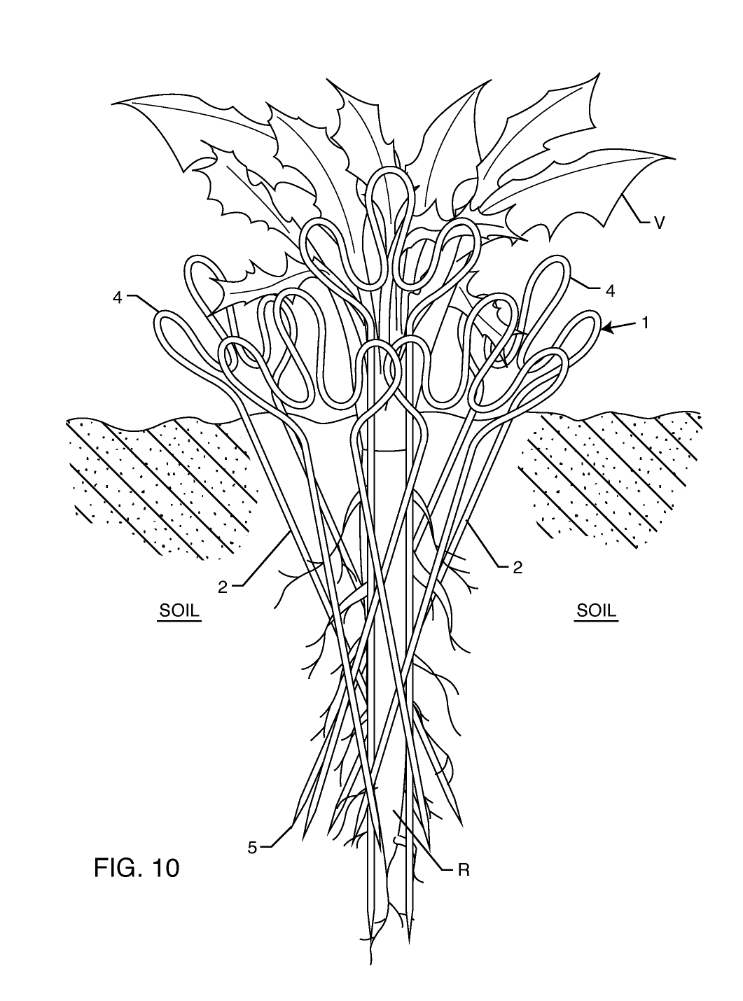

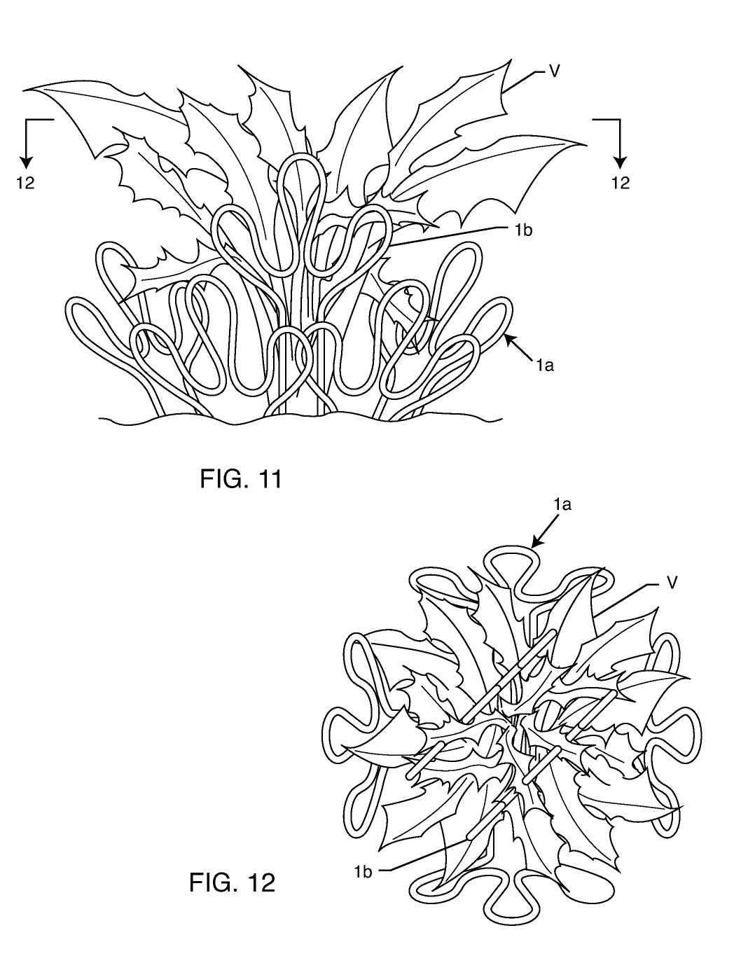

FIG. 9 shows how the devices 1 are inserted into the soil around the root system R of a vegetable plant V. FIG. 10 shows the resulting configuration that will protect the root system R. The devices 1 may be inserted into the soil far enough to protect the root system R and can be inserted further as the root system R grows deeper.

FIGS. 11 and 12 show a configuration of the devices 1 that will protect the root system R of the vegetable plant V, with an outer ring of devices 1a and two inner devices 1b that closely flank the vegetable plant V.

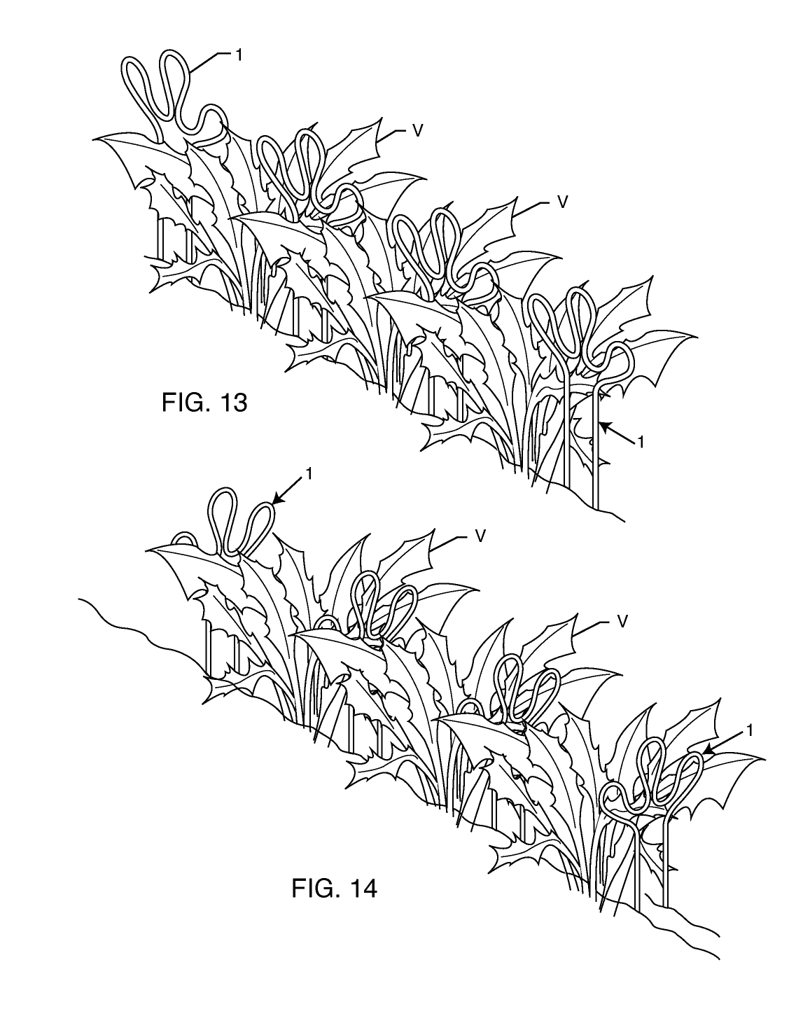

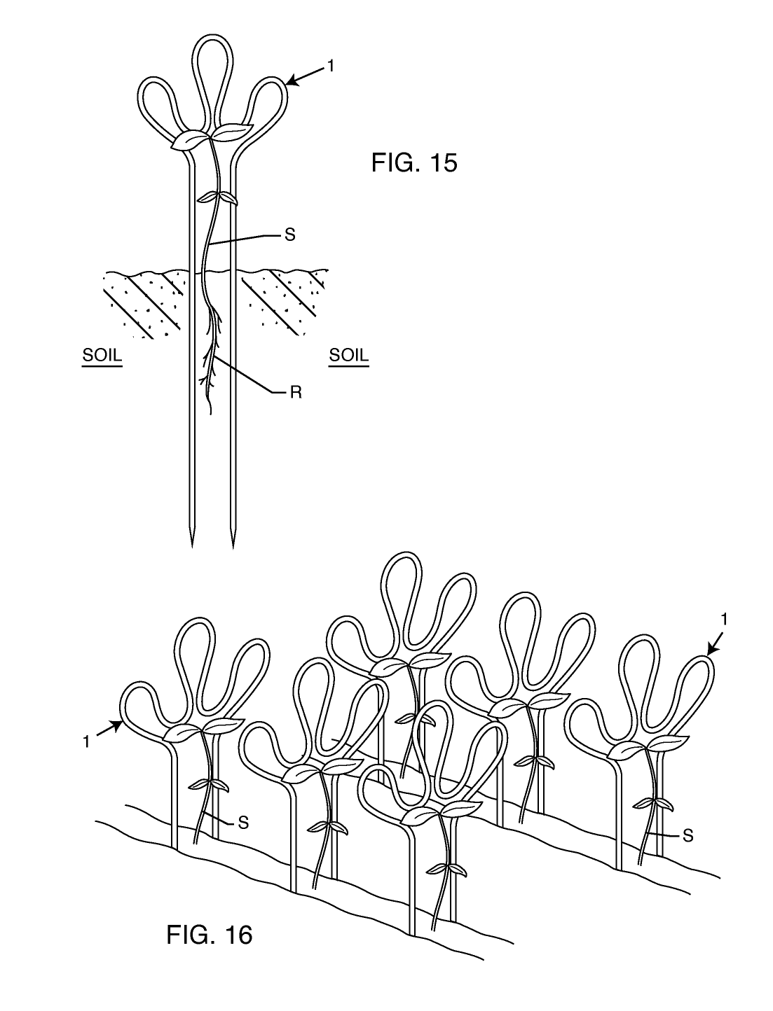

FIGS. 13 and 14 show another way of arranging the devices 1 to protect a row of vegetable plants V. In FIG. 13 each of the devices 1 are aligned in the plane of the row of vegetable plants V whereas in FIG. 14 each of the devices 1 are disposed perpendicularly to the plane of the row of vegetable plants V.

FIGS. 15 and 16 show how the devices 1 may be used to protect seedling vegetable plants S from underground dwelling mammals by inserting the segments 3 into the soil on either side of their root systems R. The devices 1 may be inserted further into the soil by thrusting down on the handles 4 as the root systems R grow deeper.

Devices 1 constructed of wire have been tested experimentally. The test plot was located in Simi Valley, Calif., and had a resident population of voracious gophers. Experience revealed that the population of gophers would eat an unacceptable percentage of vegetable plants that were planted in the test plot. The gophers typically would eat the vegetable plants from underneath, drawing the entire vegetable plant underground in order to be consumed.

Vegetable plants such as lettuce were planted in the test plot. A number of vegetable plants were protected by the insertions of the devices 1 as shown in this specification. The loss of the protected vegetable plants was reduced to an acceptable level of less than five percent. The presence of blood on the ends 6 of the devices 1 confirmed that the gophers had interacted with some of the devices 1 and had been repelled by those devices 1.

While illustrative embodiments of the devices and methods disclosed herein have been shown and described in the above description, numerous variations and alternative embodiments will occur to those skilled in the art and it should be understood that, within the scope of the appended claims, the invention may be practiced otherwise than as specifically described. Such variations and alternative embodiments are contemplated, and can be made, without departing from the scope of the invention as defined in the appended claims.

What is claimed is:

1. A method for protecting a plant having a root system immersed in soil from underground dwelling mammals, comprising the steps of:
providing at least one device comprising at least one elongated member with a first end, the first end being shaped to have a point,
inserting the first end of the elongated member of the device into the soil adjacent the root system of a plant, and
aligning the elongated member so that the first end of the elongated member is adjacent a bottom of the root system whereby the underground dwelling mammal will encounter the point of the first end of the elongated member when the underground dwelling mammal burrows toward the bottom of the root system.

2. The method according to claim 1 wherein the point of the first end is sharp enough to repel an underground dwelling mammal that encounters the first end.

3. The method according to claim 1 wherein the point of the first end is sharp enough to draw blood when an underground dwelling mammal encounters the first end.

4. The method according to claim 1 wherein the device has a plurality of elongated members with first ends that are each shaped to have a point.

5. The method according to claim 4 wherein the device comprises a handle section joined to the plurality of elongated members, and the step of inserting comprises grasping the handle section of the device and pushing the handle section toward the soil thereby thrusting the elongated members into the soil.

6. A device for protecting plants from underground dwelling mammals, comprising:
an elongated member having a handle section connected to two straight and generally parallel segments extending away from the handle section and each of the straight and generally parallel segments terminating in an end, at least one of the ends being pointed,
wherein the straight and generally parallel segments have a length sufficient to extend to the bottom of the root system of a plant when the straight and generally parallel segments are inserted into the soil adjacent the plant.

7. The device according to claim 6 wherein the point of the at least one of the ends is sharp enough to repel an underground dwelling mammal that encounters the at least one of the ends.

8. The device according to claim 6 wherein the point of the at least one of the ends is sharp enough to draw blood when an underground dwelling mammal encounters the at least one of the ends.

9. The device according to claim 6 wherein each of the straight and generally parallel segments terminates in a pointed end.

10. The device according to claim 6 wherein the device comprises a piece of wire and the ends of the device are the ends of the wire.

11. The device according to claim 10 wherein the device is formed by bending the piece of wire to form the handle section in the middle of the piece of wire and the portions of the piece of wire on either side of the handle section are straightened to become straight and generally parallel segments each terminating in an end, at least one of the ends being pointed.

12. The device according to claim 6 wherein the device is formed from extruded polymer.
